(19) United States
(12) Patent Application Publication
(10) Pub. No.: US 2010/0111498 A1
(43) Pub. Date: May 6, 2010

(54) METHOD OF CREATING A SUMMARY

(75) Inventors: Johannes Weda, Eindhoven (NL); Mauro Barbieri, Eindhoven (NL); Marco Emanuele Campanella, Eindhoven (NL); Prarthana Shrestha, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/442,717

(22) PCT Filed: Sep. 26, 2007
(86) PCT No.: PCT/IB07/53899

§ 371 Date: Mar. 25, 2009

(30) Foreign Application Priority Data
Sep. 27, 2006 (EP) 06121342.7

(51) Int. Cl. H04N 5/91

(52) U.S. Cl. 386/95; 386/E05.003

(57) ABSTRACT

Method of creating a summary (110) of a content item (100) that comprises a plurality of segments (101-1 . . . 101-7), each having a respective segment importance score. The method comprises deriving a cut point importance score for each one of N a plurality of potential cut points (102-1 . . . 102-8), each potential cut point being a boundary between two respective segments, the cut point importance score of a particular potential cut point being based on content characteristics of the two segments aligned to said potential cut point; and creating a summary (110) comprising a subset of the plurality of segments of the content item selected based on a combination of the segment importance scores and the cut point importance scores.

### TECHNICAL FIELD

The invention relates to a method of creating a summary of a content item that comprises a plurality of segments each having a respective importance score.

### TECHNICAL BACKGROUND

Availability and affordability of consumer devices equipped with the video capturing functionality have increased in recent years. This enables users to record many events they experience in their lives. This in turn results in an enormous amount of audiovisual material that is produced by a single user. Watching of the full length recordings can be quite time consuming and boring as the interesting audiovisual material is mixed with less appealing audiovisual material. Various techniques have been developed to create a summary of an arbitrary audiovisual content item.

The publication A. Girgensohn, J. Boreczky, et. Al., “A semi-automatic approach to home video editing”, CHI Letters, 2000, vol. 2, p. 81-89 discloses a system that allows users to easily create custom videos from raw video shot with a standard video camera. The system uses automatic analysis to determine suitability of portions of the raw video. Unsuitable video has fast or erratic camera motion. Based on this analysis, a numerical “unsuitability” score is computed for each frame of the video. Combined with editing rules, this score is used to identify segments (a term “clips” is used in the original publication) for inclusion in a final video summary and to select their start and end points. To create a custom video, the user selects the segments by dragging keyframes corresponding to the desired segments into the summary.

This method merely allows selection of segments suitable for inclusion in the summary, said selection based on the content analysis related to a camera motion. While the selected segments are likely to be of high quality regarding the camera motion, for the video material of homogeneous quality, this results in a rather random selection of segments by the user.

### SUMMARY OF THE INVENTION

It is an object of the invention to provide an enhanced method of creating a summary of a content item that comprises a plurality of segments each having a respective importance score which at least partially alleviates the above situation.

This object is achieved according to the invention in a method as stated above, characterized by: deriving a cut point importance score for each one of a plurality of potential cut points, each potential cut point being a boundary between two respective segments, the cut point importance score of a particular potential cut point being based on content characteristics of the two segments aligned to said potential cut point, and creating a summary comprising a subset of the plurality of segments of the content item selected based on a combination of the segment importance scores and the cut point importance scores.

The content item comprises a number of segments. A potential cut point is defined as a boundary between two adjacent segments, i.e. a point in the content item where separation of segments potentially may occur. According to the invention, a cut point importance score is derived for each potential cut point. The cut point importance score of a particular potential cut point is based on content characteristics of the two segments adjacent to the potential cut point. The content characteristics comprises components such as e.g. brightness or audio level. The invention then advantageously combines the cut point importance scores and the segments importance scores to select those segments that should make up the summary.

The resulting summary offers an improved, i.e. more consistent, selection of segments to the summary, said summary having an improved quality of presentation offered to the user. This is especially relevant for the video content of a rather homogeneous quality. The proposed method offers means to prevent selecting of segments such that e.g. a sentence comprised in the segment is abruptly cut, or the music bit of the background music is being disrupted.

In an embodiment, the cut point importance score of the potential cut point is an absolute difference of weighted norms of the content characteristics corresponding to the two segments aligned to said potential cut point. The components of content characteristics correspond to different features and therefore the values of these components are in different ranges. These different component values are scaled by means of weights to bring them into the same range and thus make their comparison possible. The weights in the weighted norm can also be used to express the relevance of specific components. The weighted norm is one-dimensional allowing therefore an easy comparison of the multidimensional content characteristics corresponding to the segments aligned to the cut point. The difference of the weighted norms of the aligned segments results in the cut point importance score of the potential cut point.

In an embodiment, the potential cut point is determined at a significant change in at least one component of the content characteristics of the neigbouring segments. A significant change in at least one component of the content characteristics results in increase of a cut point importance score. The higher the cut point importance score is the more suitable the potential cut point is. It is therefore advantageous, especially for a reasonably homogeneous video content, to place a potential cut point at the point at which a substantial change in at least one component of the content characteristics occurs.

In an embodiment, a suitability of the subset of segments to be comprised in the summary is measured by means of a suitability score, said suitability score being a weighted sum of:

the segment importance scores of segments belonging to the subset of segments, and the significant cut point importance scores of the potential cut points delimiting groups of consecutive segments with insignificant cut point importance scores for the potential cut points between the segments pertaining to the group. Insignificant refers here not to the value of the importance score of the potential cut point but to the choice of the potential cut point which has been decided to contribute less to the suitability score. The sum provides a one-dimensional measure allowing to assess the suitability of the selected subset of segments. Using weights in the weighted sum allows differentiation between the segment importance scores and the cut point importance scores. E.g. weights for the cut point importance scores lower than those for the segment importance scores mean that the user pays more attention to the actual content than for the presentation of the content related to the transition between content segments.

In an embodiment, the subset of segments selected to be comprised in the summary has the highest suitability score. Based on the segment importance scores together with the cut point importance scores various subsets of segments for a summary can be selected. To make the best choice among the possible summaries the suitability score is used. The higher the suitability score is the better the summary is.

In an embodiment, the potential cut point is determined at a camera shot boundary, said camera shot being a continuous video content recorded between succesive start and stop of a recording. This for the reasonably homogeneous video content prevents positioning of the camera shot boundary within the segment. Inclusion of such segment in the summary would be perceived as yet another cut point in the video. In case the camera shot boundary is positioned close to the potential cut point this could be quite annoying for the user. Aligning potential cut points to the camera shot boundaries prevents occurance of this annoying phenomenon.

In an embodiment, a size of a segment is not smaller than a predetermined minimum segment size, and not larger than a predetermined maximum segment size. The maximum segment size prevents the segments to be too long. This is especially relevant for a homogeneous video content for which very long (possibly uninteresting) segments, which potentially would end-up in the summary, could be created if the maximum segment size is not used. Having the segments with a restricted size enables better exploration of a variation in content characteristics within the homogeneous video content.

On the other hand making the segments too small (e.g. a single frame) is very impractical, and overwhelms with an amount of choices that can be made for a selection of short segments for inclusion in a summary. Setting the minimum/maximum constraints on the segment size results in a rich choice of segments and potential cut points, sufficient to capture short-lived features, and at the same time not too long to prevent the overall summary to be too long. It also enables a control over the computational complexity that is needed to arrive at the summary. As for the larger set of segments more computational effort is needed to arrive at the summary.

In an embodiment, the potential cut point is chosen such that it has the highest cut point importance score among the admissible potential cut points, said admissible potential cut points providing the segment size not smaller than the predetermined minimum segment size and not larger than the predetermined maximum segment size. In short, this embodiment enables choosing the most suitable potential cut point from all possible potential cut points that guarantee the segment size to stay within the predetermined limits, and said suitability measured with a cut point importance score.

In an embodiment, the minimum segment size and maximum segment size are explicitly provided by a user. The user has a rough idea of what are suitable values for the minimum and the maximum segment sizes as the user has himself/herself captured the video content and knows what kind of events are captured on the video.

The user choice for minimum/maximum segment size also reflects what attention span the user wants to give to events captured in the video content. Furthermore, through setting the maximum and minimum segment sizes the user influences the time he/she wants to spend on creating the summary. The smaller they are the more segments and the more potential cut points are available and therefore more computation time is required to make an appropriate selection of segments for the summary.

In an embodiment, a size of the summary is provided by the user. It allows the user to indicate how much time he/she is willing to spend on watching the summary. Consider, a video content captured during a vacation. The size of a summary could be large in a situation when the user watches the resulting summary alone or with his/her vacation companion. When the user watches the summary with friends the summary size could be short, as the user wants to show just the most important highlights of his/her vacation.

In an embodiment, the subset of segments selected to the summary providing the predetermined size has the highest suitability score. The targeted summary size could be achieved by various selections of segments. The best summary among all possible selections has the highest suitability score providing the best content selection and presentation quality.

The invention further provides a device for use in the method according to the invention. Advantageous embodiments of method and device are set out in dependent claims.

### BRIEF DESCRIPTION OF THE DRAWINGS

These and other aspects of the invention will be apparent from and elucidated with reference to the embodiments shown in the drawings, in which:

FIG. 1 schematically shows a content item with a corresponding summary;

FIG. 2 illustrates a cut point importance score of a particular potential cut point being based on content characteristics of the two segments aligned to said potential cut point;

FIG. 3 shows a flow chart comprising steps of the method for creating a summary according to the invention;

FIG. 4 shows an example subset of segments to be comprised in the summary whose suitability is measured by means of a suitability score;

FIG. 5 shows two examples of the subset of segments, the subset selected to be comprised in the summary of has the highest suitability score;

FIG. 6 schematically shows that the potential cut point is determined at a camera shot boundary, said camera shot being a continuous video content recorded between successive start and stop of a recording;

FIG. 7 schematically shows the potential cut point being chosen such that it has the highest cut point importance score among the admissible potential cut points, said admissible potential cut points providing the segment size not smaller than the predetermined minimum segment size and not larger than the predetermined max segment size;

FIG. 8 shows a device configured to implement the method of the invention.

Throughout the figures, same reference numerals indicate similar or corresponding features. Some of the features indicated in the drawings are typically implemented in software, and as such represent software entities, such as software modules or objects.

### DETAILED DESCRIPTION OF THE PREFERRED EMBODIMENTS

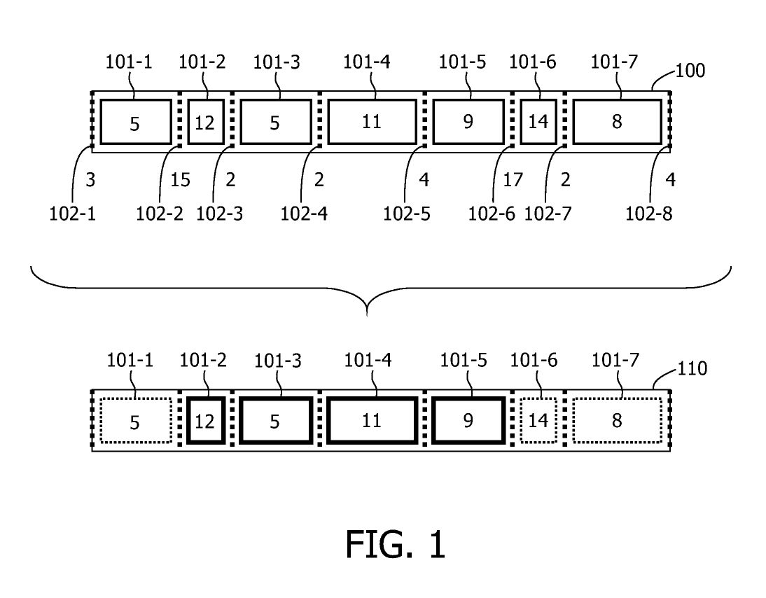

FIG. 1 schematically shows a content item 100 with a corresponding summary 110. The content item 100 comprises a plurality of segments ranging from the first segment 101-1 till the end segment 101-7. There are numerous well-known ways to determine segments. One of the alternatives is to determine segments manually. Another alternative is to automate the segmentation by using, for example, the method described in John Boreczky, Andreas Girgensohn, Gene Golovchinsky, and Shingo Uchihashi, “An Interactive Comic Book Presentation for Exploring Video”, In Proceedings of the SIGCHI Conference on Human Factors in Computing Systems (The Hague, Netherlands), ACM, pp. 185-192. The segmentation methods mentioned above are just examples, and other methods are also possible.

Each of the segments pertaining to the content item 100 has a respective segment importance score that is indicated by a numeral enclosed in boxes representing segments. These segment importance scores are either subjective segment importance scores or objective segment importance scores. The subjective segment importance scores are the scores that are introduced manually and reflect directly someone's judgment, for example the director or composer of the content item. Alternatively, the objective segment importance scores are calculated based on the content enclosed in the segments with no intervention by a human. Calculation of the objective segment importance scores is discussed, for example, in Barbieri M., Weda H., Dimitrova N., “Browsing Video Recordings Using Movie-in-a-Minute”, Proc. of the IEEE International Conference on Consumer Electronics, ICCE 2006, pp. 301-302, Jan. 7-11, 2006, Las Vegas, USA.

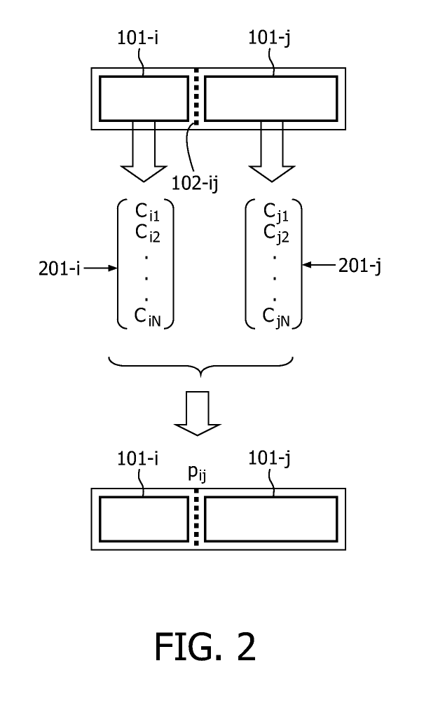

Potential cut points are defined at the boundaries of segments. The potential cut points corresponding to the content item 100 range from the potential cut point 102-1 till 102-8, and are indicated by vertical dotted lines. These potential cut points include the boundaries between two respective segments 102-2 till 102-7, as well as the end boundaries of the first segment and the last segment of the content item 100, respectively, 102-1 and 102-8. Each of the potential cut points defined for the content item 100 has a respective cut point importance score that is indicated by a numeral placed directly under the potential cut point. The derivation of the cut point importance scores will be discussed with reference to FIG. 2.

The summary 110 comprises a subset of the plurality of segments of the content item that have been selected based on their respective segment importance scores and cut point importance scores. The segment 104 is one of the selected segments. The thick solid line of a box of the segment 104 indicates that this segment has been selected for the summary 110. The dashed line of the box of the segment 103 indicates that this segment has not been selected for the summary 110.

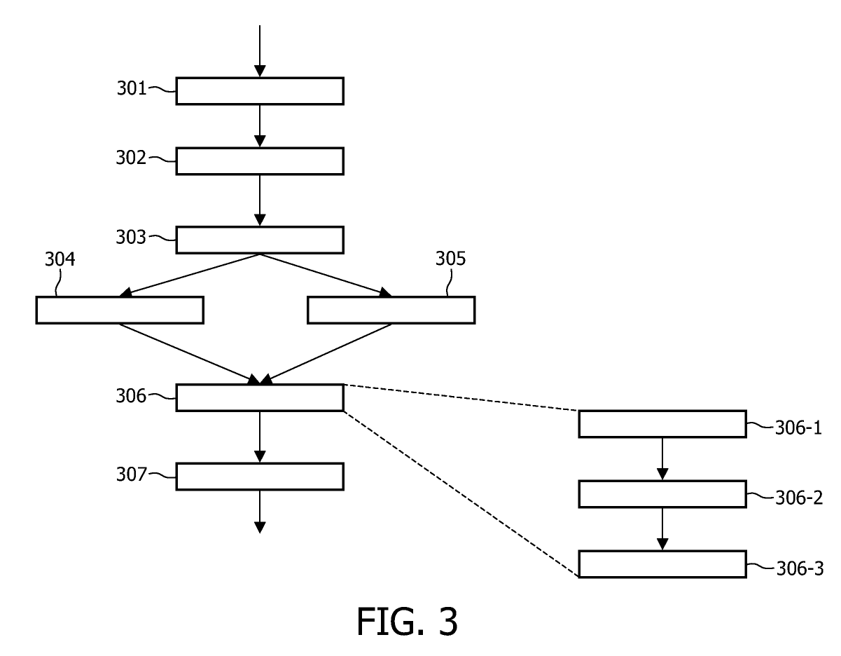

In the example shown in FIG. 1, the summary comprises segments 101-2 till 101-5. All selected segments have the importance score greater than 5. However, the segment 101-6 although it has the highest segment importance score among all segments it is not included in the summary 110. This for the reason that the potential cut point 102-6 preceding this segment is a very suitable cut point, which is expressed in a high cut point importance score with a value of 17. The potential cut point 102-7 following this segment has a very low cut point importance score with a value of 2, which means that it is not a suitable cut point. The details of the selection of segments for the summary 110 based on a combination of the segment importance scores and the cut point importance scores will be discussed with reference to FIG. 3.

The content item 100 preferably comprises an audiovisual content. The content item 100 preferably comprising: music, video, movie, clip, multimedia content, graphics, etc.

FIG. 2 illustrates a cut point importance score of a particular potential cut point being based on content characteristics of the two segments aligned to said potential cut point. FIG. 2 depicts two consecutive segments 101-i and 101-j. The potential cut point between these two segments is 102-ij. Each of the segments has content characteristics associated with it, respectively 201-i and 201-j. The content characteristics is there depicted as a vector of components, for the segment “i” the content characteristics 201-i is expressed as:

[Cᵢ₁ Cᵢ₂ . . . C_{iN}]^{T}

The difference in content characteristics of the segments aligned to the potential cut point 102-ij is reflected in a corresponding cut point importance score pᵢⱼ.

The term content characteristic refers to characteristics of the content itself, including a description or other meta-data associated with this content. Some examples of content characteristics are: luminance level, hue and saturation level, audio volume level, audio classification (speech, music, noise, crowd, etc), speech detection and sentence boundary detection, camera motion (pan, tilt, zoom, etc.), motion blur, focus blur, shot type (long, short, close up, etc.), face detection, and many others. On the other hand, items such as title, director, actors, keywords for content or a segment of the content are not content characteristics as that term is used in the present document. Each of these content characteristics can be measured for the content comprised in the segment and a value can be given to each of the plurality of the content characteristics, which is relative to some predetermined maximum.

Usually, the segment comprises, for example, a series of frames. The values of the content characteristic could be, for example, an arithmetic average or minimum of the values of the content characteristic that correspond to frames pertaining to the segment. Alternatively, such an average could be calculated for a specific subset of frames. For example, for a predetermined number of frames which are evenly spaced within the segment, or for frames that are considered as representative for the segment based on their content. Methods of calculating the content characteristic values corresponding to the segment are well-known. Calculation of the segment importance scores is discussed, for example, in Barbieri M., Weda H., Dimitrova N., “Browsing Video Recordings Using Movie-in-a-Minute”, Proc. of the IEEE International Conference on Consumer Electronics, ICCE 2006, pp. 301-302, Jan. 7-11, 2006, Las Vegas, USA.

In order to measure certain content characteristics related to the content it might be necessary to decode the content completely or partially. The formats used for audiovisual content often forthcoming in the contemporary devices with the camcorder functionality are: MPEG2, MPEG4, or DV (Digital Video). However, other formats are not excluded.

The cut point importance score is calculated such that a significant change in at least one of the components of the content characteristics of the segments aligned to the potential cut point results in a significant change in the value of the cut point importance score. To make the comparison of various components in content characteristics possible a one-dimensional norm calculated based on the content characteristics can be used. An example of such norm is a classical Euclidean distance.

In an embodiment, the cut point importance score of the potential cut point is an absolute difference of weighted norms of the content characteristics corresponding to the two segments aligned to said potential cut point. For the segment “i” the weighted norm is a weighted Euclidean distance, and is expressed as:

\sqrt{[Cᵢ₁ Cᵢ₂ . . . C_{iN}]^{T}M[Cᵢ₁ Cᵢ₂ . . . C_{iN}]}

where the matrix M is a weight matrix comprising the weight coefficients. The M matrix is diagonally dominant, i.e. the off-diagonal entries are zero-elements. The non-zero entries on the diagonal are the weights. The values of these weights are chosen so that they bring the values measured for various components of the content characteristics to the same range making the contribution of these various components to the one dimensional norm fair. Alternatively, when it is known that some of the components are more relevant than others for the assessment of the cut point importance score the weights could be chosen to reflect this difference in the component relevance.

The weights are fixed for the cut point importance score calculation for the potential cut points defined in the content item. Alternatively, the weights could vary along the content item depending on specifics of the video content. For example, since segments with speech are preferred over segments without speech, speech detection is very important. Especially starts and ends of sentences are relevant for placing the potential cut points as these are very suitable points to cut the video. This can be reflected in the values of the weights related to speech. The speech related weights could be amplified for the segments comprising speech, but set to a very low values for segments comprising e.g. landscapes without any speech present.

Furthermore, for the homogeneous video pieces of the content item, weights could be chosen so that small fluctuations in some of the components of content characteristics are amplified. Or in other words, the weighted norm is more sensitive to small component variations. However, the choice of the weights corresponding to the components should made carefully and should be tightly dependent on the content characteristics as observed over time so that noisy small local fluctuations of some of the components would not be wrongly amplified.

FIG. 3 shows a flow chart comprising steps of the method for creating a summary according to the invention. The step 301 comprises importing a raw video content corresponding to the content item. The step 302 comprises extraction of content characteristics from the imported content item. In this step the content characteristics are derived for each frame. Alternatively, the content characteristics every fixed number of frames could be calculated in order to reduce the computational complexity. Another alternative is to calculate the average content characteristics for group of frames. These are just examples how the content characteristics can be calculated, and other ways of determining the content characteristics are also possible.

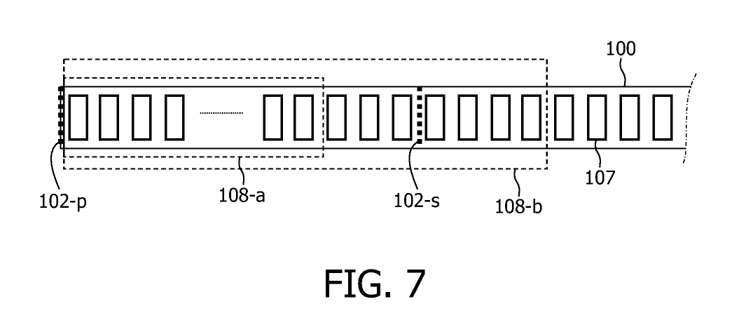

In step 303 the content item is segmented. This step comprises determining the potential cut points that in turn determine the boundaries of segments. The segmentation can be realized in many ways, for example, it could comprise dividing the content item into fixed size segments, or more advanced searching for suitable potential cut points based on the content characteristics as will be explained in FIG. 7. These are just two examples of segmentation but other ways to arrive at the segmented content item are also possible. Steps 304 and 305 can be performed independently of each other.

The step 304 comprises deriving segment importance scores, and the step 305 comprises deriving potential cut point importance scores. Although these two steps are drawn as the independent steps, taking into account that the two steps require possibly similar calculations they could be also combined in the actual implementation.

The results of steps 304 and 305 are followed by the step 306 that comprises an automatic editing. This step is further shown in more details. In the step 306-1 a number of subsets of segments are selected that could possibly be comprised in the summary. The selection of segments to the subset could be based on their segment importance scores, e.g. all segments having the segment importance scores exceeding a certain threshold are considered as candidates to be included in the summary. From such a set a number of sub-sets is selected so that these subsets fulfill additional constraints. Such additional constraints are for example a predetermined by the user the desired summary size, which within a certain tolerance should be fulfilled by the selected subset of segments, or a selected topic that should be covered by the summary created from the content item, for example the subsets that contain at least 60% of the summary time covering the selected topic.

Consequently in the step 306-2 the cost function being a function of both segment importance scores and potential cut point importance scores is evaluated.

The cost function can be e.g. a weighted sum of all segment importance scores and all potential cut point importance scores associated with the segments selected to be comprised into the summary. The cost function mentioned above is just an example and other ways of determining the cost function that uses the segment importance scores and potential cut point importance scores are also possible. These other alternatives could include additional constraints in the formulation of the cost function. An example of such a constraint could be a predetermined by the user the desired summary size, or a selected topic that should be covered by the summary created from the content item.

In step 306-3 the best subset of segments is selected based on the evaluated cost function corresponding to the selected subsets. This best subset selection is followed by the step 307 in which the summary is composed and output to the user.

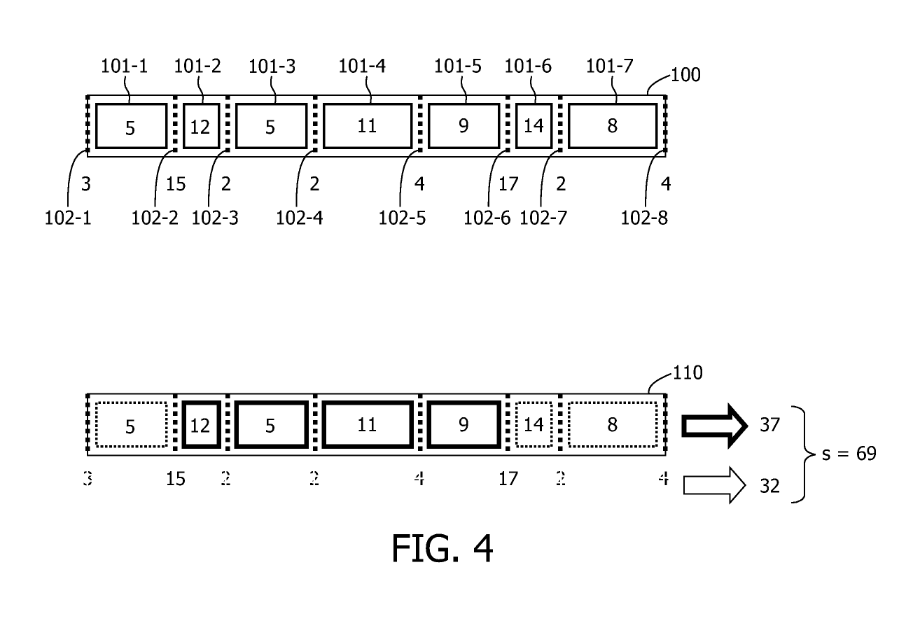

FIG. 4 shows an example subset of segments to be comprised in the summary whose suitability is measured by means of a suitability score. FIG. 4 depicts the content item with the corresponding summary 110. The summary comprises the segments 101-2 till 101-5.

The suitability score corresponding to the subset of segments is a weighted sum of:

the segment importance scores of segments belonging to the subset of segments, and

the significant cut point importance scores of the potential cut points delimiting groups of consecutive segments with insignificant cut point importance scores for the potential cut points between the segments pertaining to the group. Insignificant refers here not to the value of the importance score of the potential cut point but to the choice of the potential cut point which has been decided to contribute less to the suitability score.

The sum of segment importance scores corresponding to segments selected to the summary 110 is 37. The calculation of this sum is symbolically depicted by the thick-line arrow. The selected segments form a single group of segments delimited by the potential cut points 102-2 and 102-6. The sum of the corresponding to them cut point scores is 32. The calculation of this sum is symbolically depicted by the thin-line arrow. If no weights are applied the suitability score “s” is a sum of the computed above segment sum and cut point sum, i.e. 37 and 32, respectively, and results in the suitability score with the value of 69.

The weighing is used when differentiation between the relevance of segments and potential cut points is desired. This is the case when the segment content is more important to the user than how the selected segments align to each other in the summary.

Alternatively, other methods of assessing the suitability of the selected subset of segments for the summary can be used. For example, all possible combinations of segments could be defined, and their suitability based on the segment importance scores and cut point importance scores could be assessed by means of some score measure. Given a computational model of the constraints and a score measure function to be optimized (either maximized or minimized), the problem of segments selection is a constrained optimization problem which can be solved using well-known e.g. constraint logic programming, or local search techniques, as discussed in Aarts E. H. L., Lenstra J. K., “Local Search in Combinatorial Optimization”, John Wiley & Sons, Chichester, England, 1997 for example.

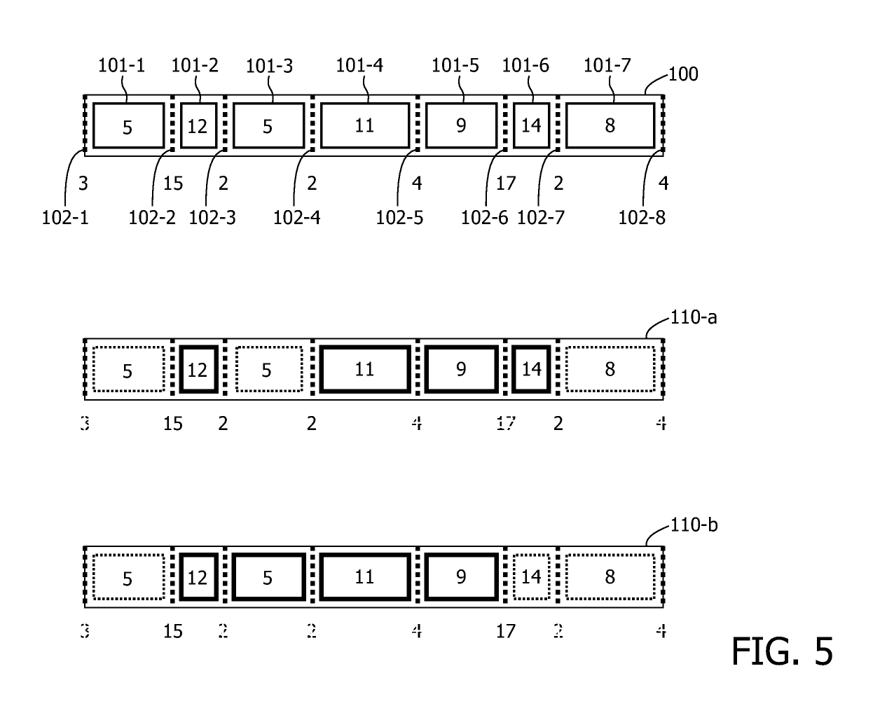

FIG. 5 shows two examples of the subset of segments, the subset selected to be comprised in the summary has the highest suitability score. In FIG. 5 two possible subsets of segments 110-a and 110-b to be comprised in the summary are depicted. Each of these subsets comprises 4 segments. The subset 110-a comprises 4 segments with the highest segment importance scores, namely, segments 101-2, 101-4, 101-5, and 101-6. The subset 110-b comprises segments 101-2 till 101-5, allowing the segment 101-6 with the segment importance score of 14 to be dropped in favor of a segment 101-3 having much lower segment importance score. The advantage of choosing the segment 101-3 is that it offers smoother transition from segment 101-2 to segment 101-4, which is expressed in a very low cut point importance scores at the potential cut points 102-3 and 102-4.

For the selection 110-a, the sum of segments importance scores of segments 101-2, 101-4, 101-5, and 101-6, results in a value of 46. There are two groups of segments formed in this subset, namely the isolated segment 101-2 and the group comprising segments 101-4 till 101-6. The potential cut points delimiting these groups are 102-2, 102-3, 102-4, and 102-7. The sum of cut point scores corresponding to these potential cut points is 21. The suitability score, for weights set to 1, is then 46+21=67.

For the selection 110-b, the suitability score, for weights set to 1, is 69. Since the suitability score corresponding to the selection 110-b is higher than that for the selection 110-a, the subset of segments 110-b is chosen for the summary.

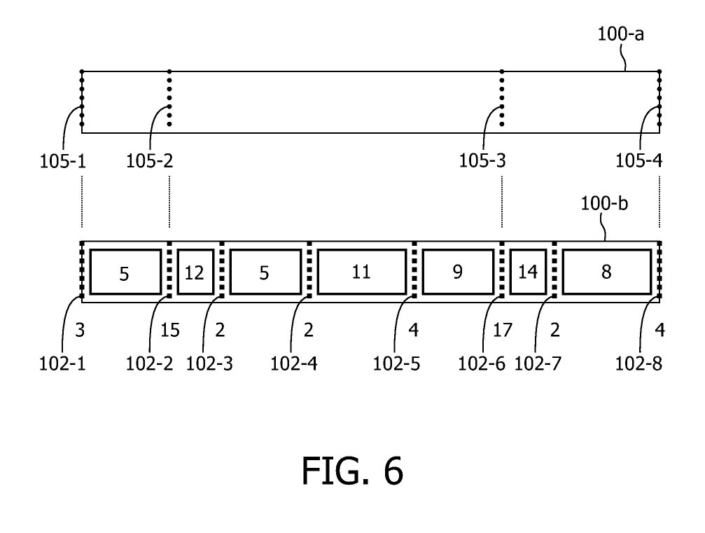

FIG. 6 schematically shows that the potential cut point is determined at a camera shot boundary, said camera shot being a continuous video content recorded between successive start and stop of a recording. The content item 100-a depicts a raw video with the boundaries of the camera shots 105-1 till 105-4. The content item 100-b depicts segmented video content corresponding to the content item 100-a. Segment boundaries 102-1, 102-2, 102-6, and 102-8 in 100-b are aligned with the respective camera shot boundaries 105-1, 105-2, 105-3, and 105-4 in 100-a. The camera shot boundaries can be maintained by setting markers in the video content or by analysis of the video content. For DV video format, camera shots can be easily detected through searching for discontinuities in the DV timestamps. Many other methods for shot cut detection are known, e.g. R. Lienhart, Comparison of Automatic Shot Boundary Detection Algorithms, Proceedings of Storage and Retrieval for Image and Video Databases VII, January 1999, San Jose, USA, pp. 290-301.

In an embodiment, the size of the segment is not smaller than a predetermined minimum segment size, and not larger than a predetermined maximum segment size. The maximum segment size prevents the segments to be too long. This is especially relevant for a homogeneous video content for which very long (possibly uninteresting) segments, which potentially would end-up in the summary, could be created if the maximum segment size is not used. Having the segments with a restricted size enables better exploration of a variation in content characteristics within the homogeneous video content.

On the other hand making the segments too small (e.g. a single frame) is very impractical, and overwhelms with an amount of choices that can be made for a selection of short segments for inclusion in a summary. Setting the minimum/maximum constraints on the segment size results in a rich choice of segments and potential cut points, sufficient to capture short-lived features, and at the same time not too long to prevent the overall summary to be too long. It also enables a control over the computational complexity that is needed to arrive at the summary. As for the larger set of segments more computational effort is needed to arrive at the summary.

FIG. 7 schematically shows the potential cut point being chosen such that it has the highest cut point importance score among the admissible potential cut points, said admissible potential cut points providing the segment size not smaller than the predetermined minimum segment size and not larger than the predetermined max segment size. The start boundary of the segment to be created is at the potential cut point 102-p. The segment with the predetermined minimum segment size starting at 102-p is depicted as 108-a. The segment with the predetermined maximum segment size starting at 102-p is depicted as 108-b. The end of the segment to be created can be at the potential cut point that is at boundary of frames that belong to the segment with the maximum segment size but are not in the segment with the minimum segment size, both segments starting at 102-p. This set of potential cut points is called admissible. From this set of potential cut points a most suitable potential cut point can be chosen, said potential cut point having the highest cut point importance score.

In an embodiment, the minimum segment size and maximum segment size are explicitly provided by a user. The user has a rough idea of what are suitable values for the minimum and the maximum segment sizes as the user has himself/herself captured the video content and knows what kind of events are captured on the video. From a perception point of view the recommended minimum segment is about 1-2 seconds, which is equivalent to 25-50 frames. The recommended maximum size is about 10-50 seconds, which corresponds to 250-1250 frames.

In an embodiment, a size of the summary is provided by the user. It allows the user to indicate how much time he/she is willing to spend on watching the summary. The user interface is provided to enable the user to input the size of the summary.

In an embodiment, the subset of segments selected to the summary providing the predetermined size has the highest suitability score. The summary size could be achieved by various selections of segments. The best summary among all possible selections has the highest suitability score providing the best content selection and presentation quality.

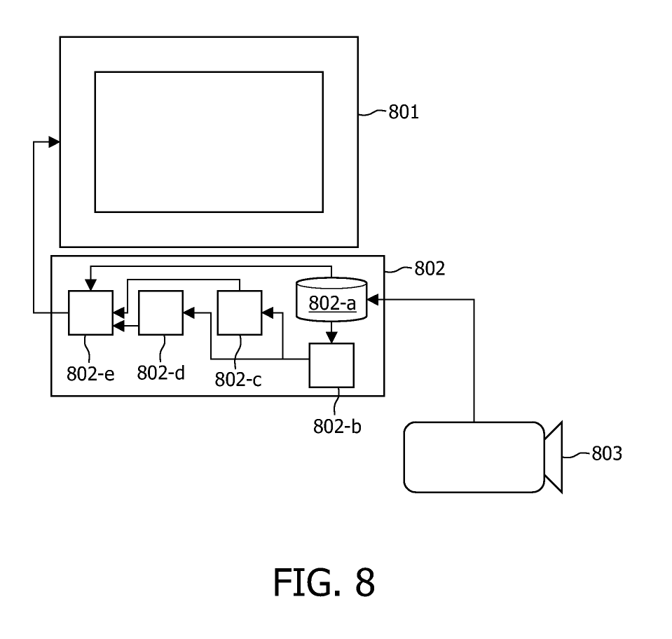

FIG. 8 shows a device 802 configured to implement the method of the invention. The raw video content is imported to the device 802, which could be a video recorder equipped in the hard disk 802-a or other storage means. The video content is stored on the hard disk 802-a and further fed into the segmentation means 802-b, which segment the content item into segments with the corresponding potential cut points. The means 802-c derive the segment importance scores corresponding to the segments as provided by the segmentation means 802-b. The means 802-d derive a cut point importance score for each one of a plurality of potential cut points as provided by the segmentation means 802-b. The means 802-e evaluate perform the steps 306 and 307 of the method of this invention, which correspond respectively to the automatic editing, and composing and outputing the summary. The outputed summary is displayed on the TV 801 to the user.

It should be noted that the above-mentioned embodiments illustrate rather than limit the invention, and those skilled in the art will be able to design many alternative embodiments without departing from the scope of the appended claims. For instance instead of audiovisual content item the audio item could be used.

In the accompanying claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. Method of creating a summary (110) of a content item (100) that comprises a plurality of segments (101-1 . . . 101-7) each having a respective segment importance score, characterized by:
deriving a cut point importance score for each one of a plurality of potential cut points (102-1 . . . 102-8), each potential cut point being a boundary between two respective segments, the cut point importance score of a particular potential cut point being based on content characteristics of the two segments aligned to said potential cut point; and
creating a summary (110) comprising a subset of the plurality of segments of the content item selected based on a combination of the segment importance scores and the cut point importance scores.

2. The method as claimed in claim 1, wherein the cut point importance score of the potential cut point is an absolute difference of weighted norms of the content characteristics (201-i, 201-j) corresponding to the two segments (101-i, 101-j) aligned to said potential cut point (102-ij).

3. The method as claimed in claim 1, wherein the potential cut point (102-ij) is determined at a significant change in at least one component of the content characteristics of the neighbouring segments.

4. The method as claimed in claim 1, wherein a suitability of the subset of segments to be comprised in the summary (110) is measured by means of a suitability score, said suitability score being a weighted sum of:
the segment importance scores of segments belonging to the subset of segments, and
the significant cut point importance scores of the potential cut points delimiting groups of consecutive segments with insignificant cut point importance scores for the potential cut points between the segments pertaining to the group.

5. The method as claimed in claim 4, wherein the subset of segments selected to be comprised in the summary (110) has the highest suitability score.

6. The method as claimed in claim 1, wherein the potential cut point (e.g. 102-2) is determined at a camera shot boundary (e.g. 105-2), said camera shot being a continuous video content recorded between succesive start and stop of a recording.

7. The method as claimed in claim 1, wherein a size of the segment is not smaller than a predetermined minimum segment size, and not larger than a predetermined maximum segment size.

8. The method as claimed in claim 7, wherein the potential cut point is chosen such that it has the highest cut point importance score among the admissible potential cut points, said admissible potential cut points providing the segment size not smaller than the predetermined minimum segment size and not larger than the predetermined maximum segment size.

9. The method as claimed in claim 7, wherein the minimum segment size and maximum segment size are explicitly provided by a user.

10. The method as claimed in claim 1, wherein a size of the summary is provided by the user.

11. The method as claimed in claim 10, wherein the subset of segments selected to the summary (110) providing the predetermined size has the highest suitability score.

12. A device operable to provide a means (802-d) to derive a cut point importance score for each one of a plurality of potential cut points (102-1 . . . 102-8), each potential cut point being a boundary between two respective segments, the cut point importance score of a particular cut point being based on content characteristics of the two segments aligned to said potential cut point, and a means (802-e) to create a summary comprising a subset of the plurality of segments (101-1 . . . 101-7) of the content item (100) selected based on a combination of the segment importance scores and the cut point importance scores, said device being operable according to the method claimed in claim 1.

13. A device as claimed in claim 12, further comprising a means (802-b) to segment the content item (100) such that the potential cut point (102-ij) is determined at a significant change in at least one of components of the content characteristics of the neighbouring segments.

14. A device as claimed in claim 12, further comprising a means (802-b) to segment the content item (100) such that the potential cut point (102-ij) is determined at a camera shot boundary, said camera shot being a continuous video content recorded between succesive start and stop of recording.

15. A device as claimed in claim 13, wherein the means (802-b) to segment the content item (100) is configured such that the size of segments is not smaller than a predetermined minimum segment size, and not larger than a predetermined maximum segment size.

16. A device as claimed in claim 12, further comprising a user interface means to enable the user to provide at least one of: the minimum segment size, the maximum segment size, or the size of the summary.

17. Software executable on device hardware for implementing a method as claimed in claim 1.
